(19) United States
(12) Patent Application Publication
(10) Pub. No.: US 2014/0276467 A1
(43) Pub. Date: Sep. 18, 2014

(54) HANGING BAG ASSEMBLY FOR ENTERAL FEEDING SYSTEMS AND METHODS OF SAME

(71) Applicant: ZEVEX, INC., Salt Lake City, UT (US)

(72) Inventor: Daniel A. Martel, Stansbury, UT (US)

(21) Appl. No.: 13/829,372

(22) Filed: Mar. 14, 2013

(51) Int. Cl. A61J 1/14

(52) U.S. Cl. CPC A61J 1/1462
USPC 604/257; 29/426.2

(57) ABSTRACT

A feeding bag system and method of preparing a feeding system is described. The system can include an adapter cap having a threaded portion for threadbly receiving the feeding bottle, a funnel-shaped portion having a tip portion configured to cooperate with an enteral feeding tube, a vent passageway disposed through the adapter cap, and a fluid passageway disposed through the funnel-shaped portion. The system can also include a bag configured to be suspended by a medical hanger. The bag may include walls defining an inner cavity, an upper opening for positioning the feeding bottle therethrough, and a sealed lower portion. The sealed lower portion can include an aperture configured to receive a portion of the adapter cap therethrough.

### FIELD OF THE INVENTION

The present invention is generally directed to a hanging bag assembly for enteral feeding systems and methods of the same.

### BACKGROUND OF THE INVENTION

Enteral feeding of patients is a common a medical procedure for patients whose physical condition does not require intravenous feeding, but at the same time are not yet prepared to take soft food or a liquid diet in normal manner. In some cases, enteral feeding can allow for a more complete diet than a diet provided by parenteral solution administration or with soft food if the patient is, for example, a child who is unwilling to eat.

It is known to use plastic bag containers that hold and store enteral feeding solution. Such plastic bag containers include an upper sealable mouth for filling the bag with solution, and a lower outlet for connection with a fluid delivery tube. These containers are relatively complicated, expensive to manufacture, and are not suitable for re-use. These containers also require enteral feeding solution to be poured through the sealable mouth, which can be burdensome and messy.

There is a need for an improved hanging bag assembly for enteral feeding systems that is simple, reliable, and inexpensive.

### SUMMARY OF THE INVENTION

The present invention may be embodied as method of preparing an enteral feeding system. The method can comprise providing a feeding bag system including a feeding bottle, an adapter cap, and a bag. The feeding bottle can have a removable feeding cap. The adapter cap can have a threaded portion for threadbly receiving the feeding bottle, a funnel-shaped portion having a tip portion configured to cooperate with an enteral feeding tube, a vent passageway disposed through the adapter cap, and a fluid passageway disposed through the funnel-shaped portion. The bag may be configured to be suspended. The bag can include walls defining an inner cavity, an upper opening for inserting the feeding bottle therethrough, and a sealed lower portion. The sealed lower portion may include an aperture. The method can also comprise replacing the feeding cap with the adapter cap by removing the feeding cap from the feeding bottle and attaching the adapter cap to the feeding bottle. Additionally, the method may include inserting the feeding bottle through the upper opening of the bag and into the inner cavity such that the aperture receives a portion of the adapter cap therethrough, and suspending the bag with the received feeding bottle from a medical stand.

The present invention can also be embodied as a feeding bag system for providing enteral feed from a feeding bottle. The system can include an adapter cap having a threaded portion for threadbly receiving the feeding bottle, a funnel-shaped portion having a tip portion configured to cooperate with an enteral feeding tube, a vent passageway disposed through the adapter cap, and a fluid passageway disposed through the funnel-shaped portion. The system can also include a bag configured to be suspended by a medical hanger. The bag may include walls defining an inner cavity, an upper opening for positioning the feeding bottle therethrough, and a sealed lower portion. The sealed lower portion can include an aperture configured to receive a portion of the adapter cap therethrough.

### BRIEF DESCRIPTION OF THE DRAWINGS

In the drawings:

FIG. 1 shows the feeding bag system 10 in accordance with an embodiment of the present invention;

FIG. 2 is perspective view of an adapter cap 20 for use with the feeding bag system shown in FIG. 1;

FIG. 3 is a side view of the adapter cap 20 shown in FIG. 2;

FIG. 4 is top view of a bag 30 for use with the system shown in FIG. 1; and

FIG. 5 is a flowchart showing a method 100 according to another embodiment of the present invention.

### DETAILED DESCRIPTION OF THE INVENTION

FIG. 1 depicts a feeding bag system 10 formed in accordance with an embodiment of the present invention. The system 10 can include an adapter cap 20 and a bag 30, which can be used to provide liquid from a feeding bottle 40 to a patient via a medical pump 50.

As shown in FIGS. 2 and 3, the adapter cap 20 may include a threaded portion 21 for threadbly receiving the feeding bottle 40. The adapter cap 20 can have a funnel-shaped portion 22, including a tip portion 22a configured to cooperate with an enteral feeding tube 60. The adapter cap 20 can also include a vent passageway 23 disposed through the adapter cap 20, and a fluid passageway 24 disposed through the funnel-shaped portion 22 and tip portion 22a. An annular seat portion 25 can be provided for being seated against a portion of the bag 30. The adapter cap 20 can also include one or more staking features 26, which can be provided to hold a washer 26a in place. The washer 26a can be disposed about an entranceway 24a of the fluid passageway 24 to form a liquid-tight seal between adapter cap 20 and feeding bottle 40.

The adapter cap 20 can be made of a plastic material, and be partially, or completely translucent such that liquid inside the adapter cap 20 can be observed by a caregiver. Graduation marks 27 may be provided on the funnel-shaped portion 22 to allow a caregiver to determine the fluid level inside the adapter cap 20. It is also contemplated that the graduation marks 27 can be included on tip portion 22a of adapter cap 20.

FIG. 4 shows details of bag 30, which can be made of a clear plastic material, such as polyethylene. The bag 30 configured to be suspended by a medical hanger 70 (shown in FIG. 1), for example, by providing an aperture 31 through the bag 30. The bag 30 may include walls 32 defining an inner cavity 33. The walls 32 can be made for example, by adhering two adjacent sheets of plastic together with an adhesive. The walls 32 can define a sealed lower portion 35, as well as provide an abutting surface 32a for receiving the annular seat portion 25 of the adapter cap 20. An upper opening 34 in the bag 30 may be provided for positioning the feeding bottle 40 therethrough, and into the inner cavity 33. In one example, the upper opening 34 of the bag 30 is about as large as the sealed lower portion of the bag 30. In another example, the majority of the bag 30 is unsealed. The sealed lower portion 35 can include an aperture 36 configured to receive a portion of the adapter cap 20 therethrough. The bag 30 may provide a surface 37 for a caregiver to write or place patient information on the bag 30. The bag advantageously can be reused for a plurality of feeding operations.

The system 10 can include the feeding bottle 40, or a feeding bottle 40 can be provided (e.g. bought from a supplier) for use with the system 10. The feeding bottle 40 may be a standard 40 mm threaded bottle, such as a common baby bottle, containing a solution. Preferably, the feeding solution is an enteral feeding solution, such as mother's milk or a prescribed feed. Alternatively, the feeding solution may be added to the feeding bottle 40 by the caregiver. The feeding bottle 40 can have a threadably removable feeding cap (not shown) that hermetically seals the feeding bottle 40.

The system 10 may be used by replacing a feeding bottle 40 feeding cap (not shown) with the adapter cap 20. The feeding bottle 40 with adapter cap 20 can be inserted through the upper opening 34 of bag 30 and into the inner cavity 33 such that the aperture 36 receives a portion of the adapter cap 20 therethrough. For example, the annular seat portion 25 can rest against the abutting portion 32a of bag 30, and the funnel-shaped portion 22 and tip portion 22a can extend through the aperture 36 of the bag 30. The bag 30 carrying the feeding bottle 40 and adapter cap 20 can be suspended by medical hanger 70, and a feeding tube 60 can be attached to the tip portion 22a of adapter cap 20. In a feeding position, the tip portion 22a of the adapter cap 20 can face downwardly such that feeding solution in the feeding bottle 40 can be fed to the pump 50 by gravity.

The present invention can also be embodied by as method 100 of preparing an enteral feeding system. As shown in FIG. 5, the method can comprise providing 110 a feeding bag system including a feeding bottle, an adapter cap, and a bag. The feeding bottle can have a removable feeding cap. The adapter cap can have a threaded portion for threadbly receiving the feeding bottle, a funnel-shaped portion having a tip portion configured to cooperate with an enteral feeding tube, a vent passageway disposed through the adapter cap, and a fluid passageway disposed through the funnel-shaped portion. The bag may be configured to be suspended. The bag can include walls defining an inner cavity, an upper opening for inserting the feeding bottle therethrough, and a sealed lower portion. The sealed lower portion may include an aperture. The method can also comprise replacing 120 the feeding cap of the feeding bottle with the adapter cap by removing the feeding cap from the feeding bottle and attaching the adapter cap to the feeding bottle. Additionally, the method may include inserting 130 the feeding bottle through the upper opening of the bag and into the inner cavity such that the aperture receives a portion of the adapter cap therethrough. The bag with the received feeding bottle can be suspended 140 from a medical stand, for example, by inserting a portion of the medical stand through the hanger aperture.

The method 100 can further comprise attaching the tip portion to the enteral feeding tube. The enteral feeding tube may be operatively connected to an enteral feeding pump for delivering fluid from the feeding bottle to a patient.

The present invention provides a simple, reliable, and inexpensive way to provide enteral feed to a patient. Unlike prior art bags, which are more complicated to use, expensive to manufacture, and must be disposed of after delivering solution to a patient, the bag of the present invention is simple to use, inexpensive to manufacture, and can be reused for a plurality of feeding operations.

Modifications and other embodiments of the invention set forth herein will be apparent to one skilled in the art to which the invention pertains in light of teachings presented in the present specification. Therefore, the invention is not to be limited to the specific embodiments disclosed, and modifications and other embodiments are intended to be included within the scope of the appended claims.

### PARTS LIST

10 Feeding bag system
20 Adapter cap
21 Threaded portion
22 Funnel-shaped portion
22a Tip portion
23 Vent passageway
24 Fluid passageway
25 Annular seat portion
26 Staking feature
26a Washer
27 Graduation marks
30 Bag
32 Walls
34 Upper opening
36 Aperture
40 Feeding bottle
50 Medical pump
60 Feeding tube
70 Medical hanger

What is claimed is:

1. A method of preparing an enteral feeding system, comprising:
providing a feeding bag system, the system including:
a feeding bottle having a removable feeding cap;
an adapter cap, including:
a threaded portion for threadbly receiving the feeding bottle;
a funnel-shaped portion having a tip portion configured to cooperate with an enteral feeding tube;
a vent passageway disposed through the adapter cap; and
a fluid passageway disposed through the funnel-shaped portion; and
a bag configured to be suspended, the bag including walls defining an inner cavity, an upper opening for inserting the feeding bottle therethrough, and a sealed lower portion, the sealed lower portion including an aperture;
replacing the feeding cap with the adapter cap by removing the feeding cap from the feeding bottle and attaching the adapter cap to the feeding bottle;
inserting the feeding bottle through the upper opening of the bag and into the inner cavity such that the aperture receives a portion of the adapter cap therethrough; and
suspending the bag with the received feeding bottle from a medical stand.

2. The method of claim 1, further comprising attaching the tip portion to the enteral feeding tube.

3. The method of claim 2, wherein the enteral feeding tube is operatively connected to an enteral feeding pump for delivering fluid from the feeding bottle to a patient.

4. The method of claim 1, wherein the feeding bottle is a 40 mm threaded bottle.

5. The method of claim 1, wherein the bag includes a hanger aperture;
wherein the bag is suspended by inserting a portion of the medical stand through the hanger aperture.

6. The method of claim 1, wherein, in a feeding position, the tip portion of the feeding bottle faces downwardly.

7. The method of claim 1, further comprising reusing the bag for a plurality of feeding operations.

8. The method of claim 1, wherein the bag is made of a clear plastic material.

9. The method of claim 8, wherein the clear plastic material is polyethylene.

10. The method of claim 1, wherein at least a portion of the adapter cap is translucent.

11. The method of claim 10, wherein the adapter cap includes graduation marks for determining a fluid level within the adapter cap.

12. A feeding bag system for providing enteral feed from a feeding bottle, comprising:
an adapter cap, including:
a threaded portion for threadbly receiving the feeding bottle;
a funnel-shaped portion having a tip portion configured to cooperate with an enteral feeding tube;
a vent passageway disposed through the adapter cap;
a fluid passageway disposed through the funnel-shaped portion; and
a bag configured to be suspended by a medical hanger, the bag including walls defining an inner cavity, an upper opening for positioning the feeding bottle therethrough, and a sealed lower portion, the sealed lower portion including an aperture configured to receive a portion of the adapter cap therethrough.

13. The system of claim 12, wherein the adapter cap includes: one or more staking features;
a washer disposed about an entranceway of the fluid passageway, the washer being held by the one or more staking features.

14. The system of claim 12, wherein the adapter cap includes an annular seating portion configured to be seated against the bag.

15. The system of claim 12, wherein the feeding bottle is a 40 mm threaded bottle.

16. The system of claim 12, wherein the bag includes a hanger aperture;
wherein the bag is configured to be suspended by the medical hanger by positioning a portion of the medical stand through the hanger aperture.

17. The system of claim 12, wherein the bag is made of a clear plastic material.

18. The system of claim 17, wherein the clear plastic material is polyethylene.

19. The system of claim 12, wherein at least a portion of the adapter cap is translucent.

20. The system of claim 19, wherein the adapter cap includes graduation marks corresponding to a fluid level of the enteral feed within the adapter cap.
